(19) United States
(12) Patent Application Publication
(10) Pub. No.: US 2016/0035289 A1
(43) Pub. Date: Feb. 4, 2016

(54) IMAGE PROCESSING DEVICE AND LIQUID CRYSTAL DISPLAY DEVICE

(71) Applicant: SHARP KABUSHIKI KAISHA, Osaka (JP)

(72) Inventors: Ken INADA, Osaka (JP); Hikaru KUKI, Osaka (JP); Asahi YAMATO, Osaka (JP)

(73) Assignee: SHARP KABUSHIKI KAISHA, Osaka (JP)

(21) Appl. No.: 14/774,494

(22) PCT Filed: Feb. 26, 2014
(86) PCT No.: PCT/JP2014/054747

§ 371 Date: Sep. 10, 2015

(30) Foreign Application Priority Data
Mar. 13, 2013 (JP) 2013-050928

(51) Int. Cl. G09G 3/34; G09G 3/36

(52) U.S. Cl. CPC G09G 3/3413; G09G 3/3611; G09G 2320/0233; G09G 2320/0646

(57) ABSTRACT

The phenomenon of the hue of an image displayed in a liquid crystal display changing depending on whether or not CABC is employed is reduced. An image processing device sets a predetermined first brightness as the backlight brightness if CABC is not to be performed, and if CABC is to be performed, sets, for each frame of an image signal displayed on the liquid crystal panel, a second luminance determined according to the gradation of the pixels in the frame. If CABC is to be performed, the image processing device corrects the gradation values of the primary colors of the pixels in each frame of the image signal according to the second luminance set for that frame and on the basis of the display characteristics of the liquid crystal panel.

A first invention is an image processing device for processing an image signal to be displayed in a liquid crystal display device that includes a backlight and a liquid crystal panel, the image processing device including: a luminance setting unit that sets a prescribed first luminance as a luminance of the backlight in a first control mode, and sets a second luminance less than the first luminance as the luminance of the backlight in a second control mode, the second luminance being determined according to gradation levels of respective pixels in a frame for each frame of the image signal, the second luminance being set lower when the gradation levels of pixels in a frame are generally darker so as to reduce power consumption at the backlight; and a correction unit that, in the second control mode, corrects pixel values in the image signal for each frame to compensate for a reduced luminance of the second luminance relative to the first luminance, wherein the pixel values in the image signal include respective gradation levels for a plurality of primary colors, and wherein the correction unit corrects the respective gradation levels for the plurality of primary colors of the pixels in accordance with display characteristics of the liquid crystal panel and the second luminance set by the luminance setting unit such that amounts of correction for the gradation levels differ between at least two of the primary colors.

A second invention is the first invention, wherein the luminance setting unit determines, from a histogram of the gradation levels in the respective pixels of the frame of the image signal, a gradation level that defines a prescribed percentile of pixels from a maximum possible gradation, and sets a luminance for the backlight that corresponds to the determined gradation level as the second luminance.

A third invention is the first or second invention, wherein the pixel values include respective gradation levels for at least three primary colors of red, green, and blue, and wherein the correction unit corrects the respective gradation levels included in the pixel values such that the amounts of correction for the respective gradation levels for red and green are less than the amount of correction for the gradation level for blue.

A fourth invention is any one of the first to third inventions, wherein the correction unit includes, for each of possible luminance values for the second luminance, a correction coefficient table that stores respective correction coefficients for the plurality of primary colors that are determined in accordance with the display characteristics of the liquid crystal panel, and wherein the correction unit corrects the respective gradation levels for the plurality of primary colors of the pixels using the respective correction coefficients prescribed for the second luminance set by the luminance setting unit.

A fifth invention is any one of the first to third inventions, wherein the correction unit includes a gradation conversion table that stores, for each of possible luminance values for the second luminance, a corrected gradation level that is determined on the basis of the display characteristics of the liquid crystal panel for each of the gradation levels for each of the primary colors of pixels in the image signal, and corrects outputs the corrected gradation levels listed in the gradation conversion table corresponding to the gradation levels of the primary colors of pixels in the image signal and the second luminance set by the luminance setting unit.

A sixth invention is a liquid crystal display device, including: the image processing device according to any one of the first to fifth inventions; a liquid crystal panel that displays images in accordance with an image signal inputted thereto; a liquid crystal driving unit that, in the first control mode, outputs to the liquid crystal panel the image signal as-is without correction, and, in the second control mode, outputs to the liquid crystal panel the image signal in accordance with the pixel values of the respective frames that have been corrected by the image processing device; a backlight provided to a rear surface of the liquid crystal panel, the backlight having a plurality of light sources and radiating light according to a light emission control signal inputted thereto; and a backlight control unit that, in the first control mode, outputs to the backlight the light emission control signal that instructs the backlight to emit light at the first luminance set by the image processing device, and, in the second control mode, outputs to the backlight the light emission control signal that instructs the backlight to emit light at the second luminance set by the image processing device.

One embodiment of the present invention is an image processing device for processing an image signal to be displayed in a liquid crystal display device that includes a backlight and a liquid crystal panel, the image processing device including: a luminance setting unit that sets a prescribed first luminance as a luminance of the backlight in a first control mode, and sets a second luminance less than the first luminance as the luminance of the backlight in a second control mode, the second luminance being determined according to gradation levels of respective pixels in a frame for each frame of the image signal, the second luminance being set lower when the gradation levels of pixels in a frame are generally darker so as to reduce power consumption at the backlight; and a correction unit that, in the second control mode, corrects pixel values in the image signal for each frame to compensate for a reduced luminance of the second luminance relative to the first luminance, wherein the pixel values in the image signal include respective gradation levels for a plurality of primary colors, and wherein the correction unit corrects the respective gradation levels for the plurality of primary colors of the pixels in accordance with display characteristics of the liquid crystal panel and the second luminance set by the luminance setting unit such that amounts of correction for the gradation levels differ between at least two of the primary colors (first configuration).

According to the first configuration, the correction unit corrects the respective gradation values (gradation levels) of the plurality of primary colors of the respective pixels in the frame according to the second luminance on the basis of the display characteristics of the liquid crystal panel in the second control mode in which the backlight emits light at the second luminance determined for each frame by the luminance setting unit. Depending on the display characteristics of the liquid crystal panel, the luminance of the backlight can differ between the first control mode and the second control mode, and a phenomenon in which the hue of the image displayed in the liquid crystal panel changes can occur. In this configuration, during the second control mode, the respective gradation values included in the pixel values are corrected respectively to values according to the second luminance on the basis of the display characteristics of the liquid crystal panel, and thus, it is possible to reduce the change in relation to the first control mode of the hue of the image displayed in the liquid crystal panel.

In the first configuration, a second configuration may be configured such that the luminance setting unit determines, from a histogram of the gradation levels in the respective pixels of the frame of the image signal, a gradation level that defines a prescribed percentile of pixels from a maximum possible gradation, and sets a luminance for the backlight that corresponds to the determined gradation level as the second luminance.

In the first or second configuration, a third configuration may be configured such that the pixel values include respective gradation levels for at least three primary colors of red, green, and blue, and such that the correction unit corrects the respective gradation levels included in the pixel values such that the amounts of correction for the respective gradation levels for red and green are less than the amount of correction for the gradation level for blue.

In any one of the first to third configurations, a fourth configuration may be configured such that the correction unit includes, for each of possible luminance values for the second luminance, a correction coefficient table that stores respective correction coefficients for the plurality of primary colors that are determined in accordance with the display characteristics of the liquid crystal panel, and such that the correction unit corrects the respective gradation levels for the plurality of primary colors of the pixels using the respective correction coefficients prescribed for the second luminance set by the luminance setting unit.

In any one of the first to third configurations, a fifth configuration may be configured such that the correction unit includes a gradation conversion table that stores, for each of possible luminance values for the second luminance, a corrected gradation level that is determined on the basis of the display characteristics of the liquid crystal panel for each of the gradation levels for each of the primary colors of pixels in the image signal, and outputs the corrected gradation levels listed in the gradation conversion table corresponding to the gradation levels of the primary colors of pixels in the image signal and the second luminance set by the luminance setting unit.

One embodiment of the present invention is a liquid crystal display, including: a liquid crystal panel that displays images in accordance with an image signal inputted thereto; a liquid crystal driving unit that, in the first control mode, outputs to the liquid crystal panel the image signal as-is without correction, and, in the second control mode, outputs to the liquid crystal panel the image signal in accordance with the pixel values of the respective frames that have been corrected by the image processing device; a backlight provided to a rear surface of the liquid crystal panel, the backlight having a plurality of light sources and radiating light according to a light emission control signal inputted thereto; and a backlight control unit that, in the first control mode, outputs to the backlight the light emission control signal that instructs the backlight to emit light at the first luminance set by the image processing device, and, in the second control mode, outputs to the backlight the light emission control signal that instructs the backlight to emit light at the second luminance set by the image processing device (sixth configuration).

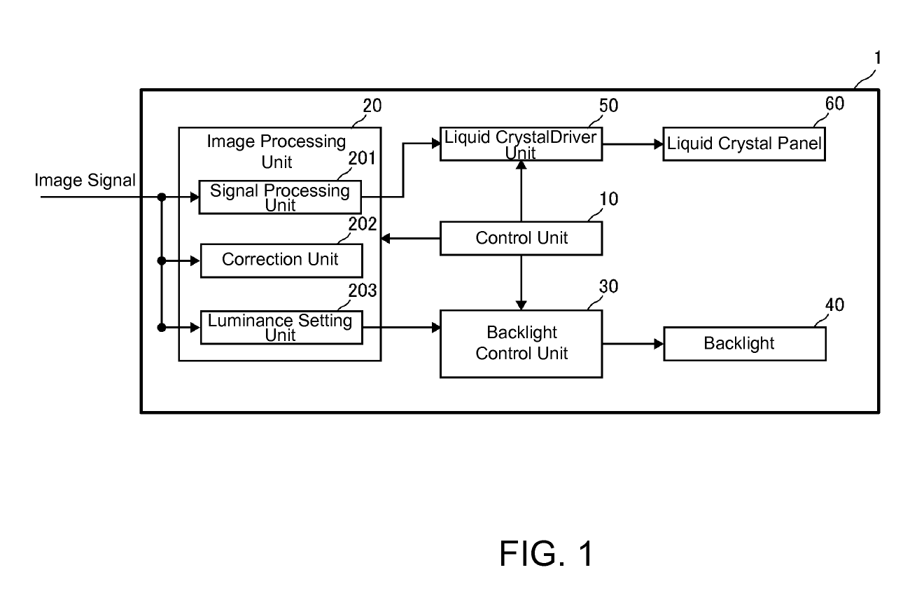

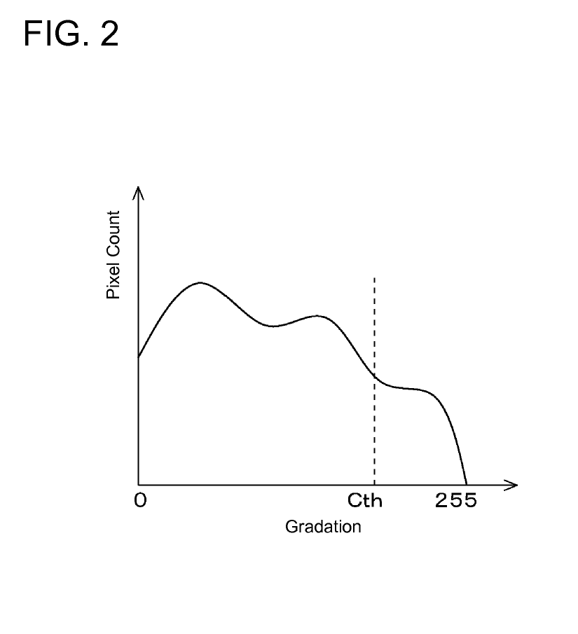

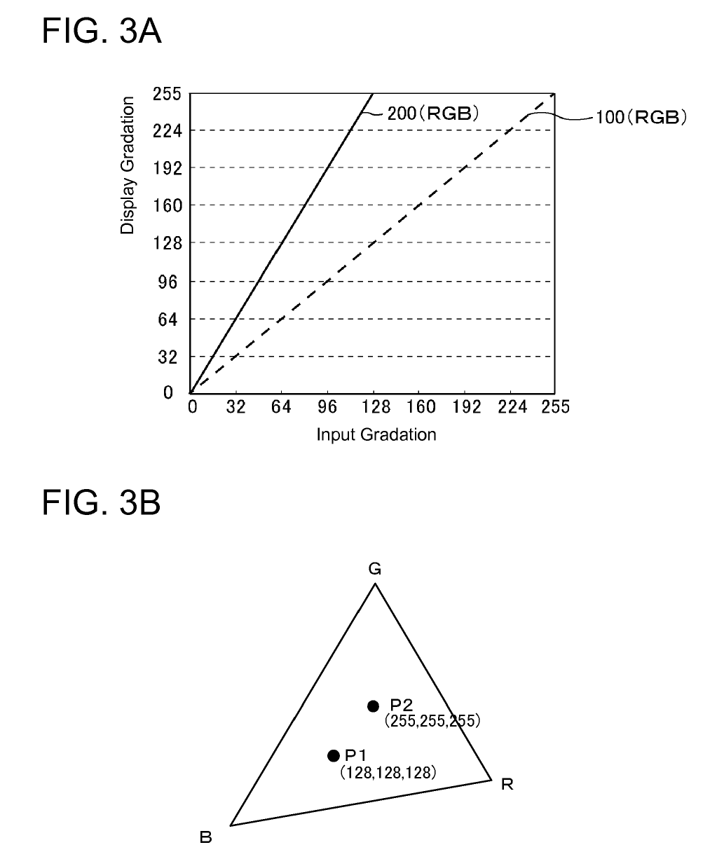

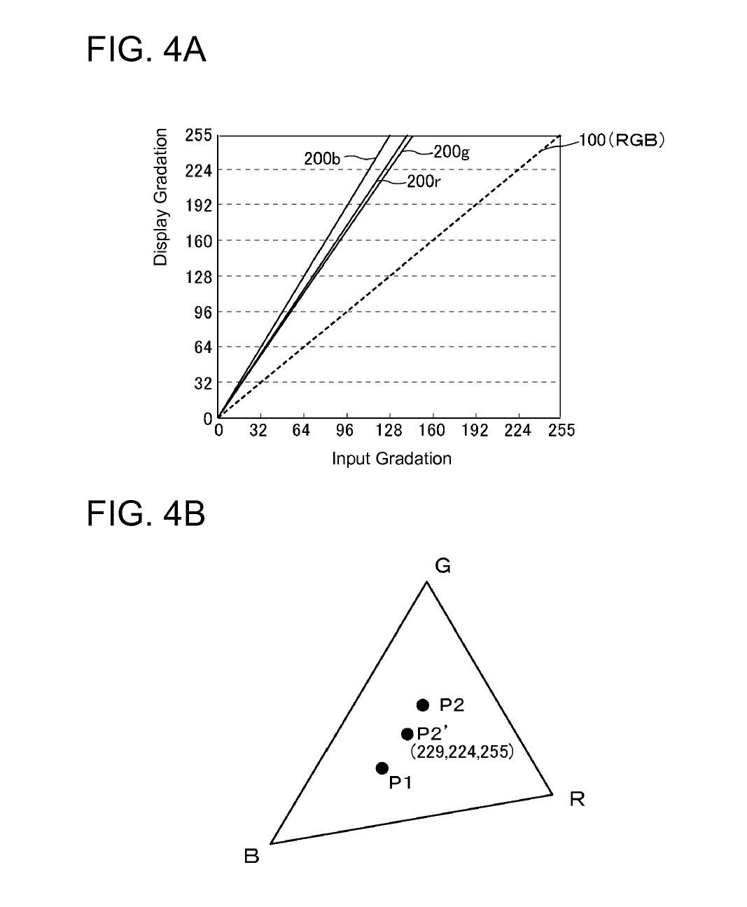

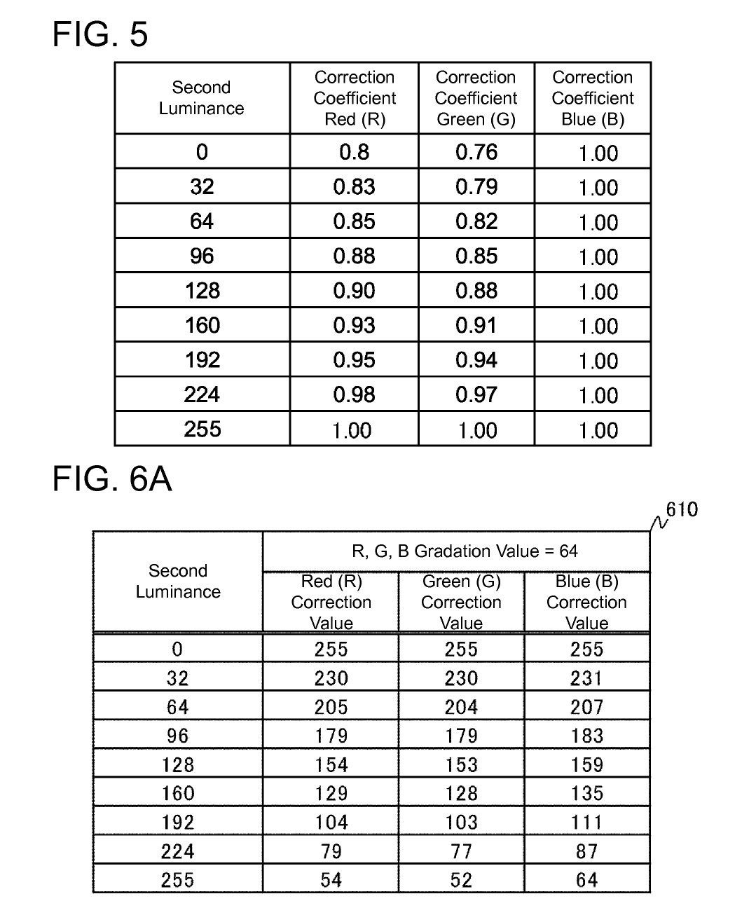

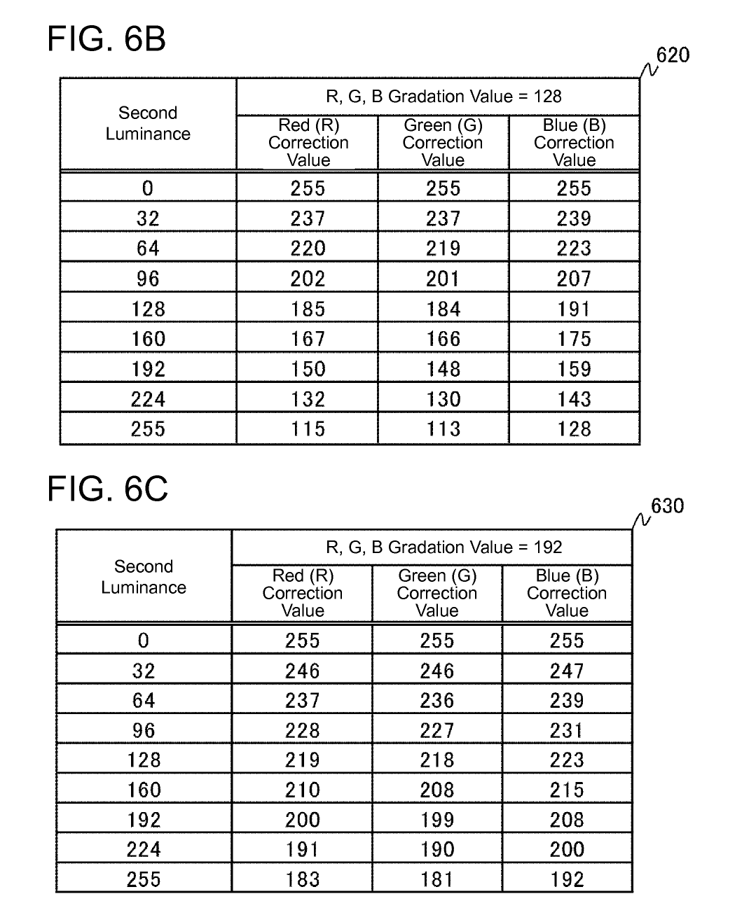

The luminance setting unit 203 sets the second luminance on the basis of the gradation values (gradation levels) of pixels included in the frame for each image signal frame when the control signal indicates second control mode. Below, the second luminance settings will be described in detail. During second control mode, the luminance setting unit 203 sets, as the gradation values of the pixels, the maximum signal values among the signal values (gradation values) of the sub-pixels included in the respective pixels. For each frame of the image signal, a histogram is generated for the gradation values of the respective pixels in the frame. The luminance setting unit 203 sets the gradation value, for which the number of pixels summed up from the maximum gradation is a number set in advance, so as to be at a luminance level of the second luminance. FIG. 2 shows an example of a histogram of a pixel gradation value included in one frame of the image signal. In the example of FIG. 2, the gradation value Cth indicates the luminance level of the second luminance. In the present embodiment, the gradation Cth is set as the second luminance such that 5% of all the pixels included in one frame are included from the gradation value Cth to the maximum gradation “255.”

1. An image processing device for processing an image signal to be displayed in a liquid crystal display device that includes a backlight and a liquid crystal panel, the image processing device comprising:
a luminance setting unit that sets a prescribed first luminance as a luminance of the backlight in a first control mode, and sets a second luminance less than the first luminance as the luminance of the backlight in a second control mode, the second luminance being determined according to gradation levels of respective pixels in a frame for each frame of the image signal, the second luminance being set lower when the gradation levels of pixels in a frame are generally darker so as to reduce power consumption at the backlight; and
a correction unit that, in the second control mode, corrects pixel values in the image signal for each frame to compensate for a reduced luminance of the second luminance relative to the first luminance,
wherein the pixel values in the image signal include respective gradation levels for a plurality of primary colors, and
wherein the correction unit corrects the respective gradation levels for the plurality of primary colors of the pixels in accordance with display characteristics of the liquid crystal panel and the second luminance set by the luminance setting unit such that amounts of correction for the gradation levels differ between at least two of the primary colors.

2. The image processing device according to claim 1, wherein the luminance setting unit determines, from a histogram of said gradation levels in the respective pixels of the frame of the image signal, a gradation level that defines a prescribed percentile of pixels from a maximum possible gradation, and sets a luminance for the backlight that corresponds to the determined gradation level as the second luminance.

3. The image processing device according to claim 1,
wherein the pixel values include respective gradation levels for at least three primary colors of red, green, and blue, and
wherein the correction unit corrects the respective gradation levels included in the pixel values such that the amounts of correction for the respective gradation levels for red and green are less than the amount of correction for the gradation level for blue.

4. The image processing device according to claim 1,
wherein the correction unit includes, for each of possible luminance values for the second luminance, a correction coefficient table that stores respective correction coefficients for the plurality of primary colors that are determined in accordance with the display characteristics of the liquid crystal panel, and
wherein the correction unit corrects the respective gradation levels for the plurality of primary colors of the pixels using the respective correction coefficients prescribed for the second luminance set by the luminance setting unit.

5. The image processing device according to claim 1, wherein the correction unit includes a gradation conversion table that stores, for each of possible luminance values for the second luminances, a corrected gradation level that is determined on the basis of the display characteristics of the liquid crystal panel for each of the gradation levels for each of the primary colors of pixels in the image signal, and outputs the corrected gradation levels listed in the gradation conversion table corresponding to the gradation levels of the primary colors of pixels in the image signal and the second luminance set by the luminance setting unit.

6. A liquid crystal display device, comprising:
the image processing device according to claim 1;
a liquid crystal panel that displays images in accordance with an image signal inputted thereto;
a liquid crystal driving unit that, in the first control mode, outputs to the liquid crystal panel the image signal as-is without correction, and, in the second control mode, outputs to the liquid crystal panel the image signal in accordance with the pixel values of the respective frames that have been corrected by the image processing device;
a backlight provided to a rear surface of the liquid crystal panel, the backlight having a plurality of light sources and radiating light according to a light emission control signal inputted thereto; and
a backlight control unit that, in the first control mode, outputs to the backlight the light emission control signal that instructs the backlight to emit light at the first luminance set by the image processing device, and, in the second control mode, outputs to the backlight the light emission control signal that instructs the backlight to emit light at the second luminance set by the image processing device.
